(19) United States
(12) Patent Application Publication
(10) Pub. No.: US 2018/0197262 A1
(43) Pub. Date: Jul. 12, 2018

(54) TRACKING A HARMFUL COMBINATION OF ARTICLES

(71) Applicant: International Business Machines Corporation, Armonk, NY (US)

(72) Inventors: Gopal K. Bhageria, Kolkata (IN); Vijay Ekambaram, Tamilnadu (IN); Sarbajit K. Rakshit, Kolkata (IN)

(21) Appl. No.: 15/403,785

(22) Filed: Jan. 11, 2017

(51) Int. Cl. G06Q 50/26; G06Q 10/08

(52) U.S. Cl. CPC G06Q 50/265; G06Q 10/0838

(57) ABSTRACT

A method of tracking a harmful combination of articles which includes: identifying a plurality of articles at an originating location, the identifying including a type and quantity of the plurality of articles; matching the plurality of articles with a repository of article descriptions that includes descriptive combinations of the articles that could combine to be a dangerous instrumentality to result in a plurality of matched articles with a potential to harm persons or property; identifying transport routes for the plurality of matched articles from the originating location to a terminating geographical zone; estimating a degree of completion of the dangerous instrumentality; and estimating a danger score of the plurality of matched articles, the danger score a composite of the type and quantity of the plurality of matched articles moved to the terminating geographical zone and the degree of completion of the dangerous instrumentality.

### BACKGROUND

The present exemplary embodiments pertain to security regimens in which articles are examined for their potential to harm persons or property and, more particularly, pertain to recognizing articles from one or more locations that alone may not be harmful and predicting a combination of these articles that may be harmful.

Airplane passengers must proceed through airport security before the passengers are allowed to board an aircraft. The airport security includes scanning the passenger and any carryon baggage that the passenger intends to bring on the aircraft. The airport security scanning typically looks for harmful objects such as sharp tools, firearms and explosives. The passenger's checked baggage may also be screened for these harmful objects.

To a lesser extent, train and bus passengers may also be screened for harmful objects. Further, cargo that is shipped by any conveyance lists the contents of the cargo in a cargo manifest and any harmful objects in the cargo would become apparent from the cargo manifest.

There is no tool available at the disposal of security officers that would enable the security officers to find out harmless objects that could be used for terrorizing or harming other fellow passengers/persons. Currently security officers rely solely on their training manual where a list of harmful articles is presented but in the fast changing world where information flows instantly, anti-social elements are using innovative methods to develop harmful objects using articles that by themselves appear harmless.

### BRIEF SUMMARY

The various advantages and purposes of the exemplary embodiments as described above and hereafter are achieved by providing, according to an aspect of the exemplary embodiments, a method of tracking a harmful combination of articles comprising: identifying a plurality of articles at one or more originating locations, the identifying including a type of the plurality of articles and a quantity of the plurality of articles; matching the plurality of articles with a repository of article descriptions that includes descriptive combinations of the articles that could combine to be a dangerous instrumentality to result in a plurality of matched articles with a potential to harm persons or property; identifying transport routes for the plurality of matched articles from the one or more originating locations to a terminating geographical zone; estimating a degree of completion of the dangerous instrumentality; and estimating a danger score of the plurality of matched articles, the danger score a composite of the type of the plurality of matched articles moved to the terminating geographical zone, the quantity of the plurality of matched articles moved to the terminating geographical zone and the degree of completion of the dangerous instrumentality.

According to another aspect of the exemplary embodiments, there is provided a system for tracking a harmful combination of articles comprising: a computer readable storage medium; and a processor that executes the instructions to perform the following functions: identify a plurality of articles at one or more originating locations, the identify including a type of the plurality of articles and a quantity of the plurality of articles; match the plurality of articles with a repository of article descriptions that includes descriptive combinations of the articles that could combine to be a dangerous instrumentality to result in a plurality of matched articles with a potential to harm persons or property; identify transport routes for the plurality of matched articles from the one or more originating locations to a terminating geographical zone; estimate a degree of completion of the dangerous instrumentality; and estimate a danger score of the plurality of matched articles, the danger score a composite of the type of the plurality of matched articles moved to the terminating geographical zone, the quantity of the plurality of matched articles moved to the terminating geographical zone and the degree of completion of the dangerous instrumentality.

According to a further aspect of the exemplary embodiments, there is provided a computer program product for tracking a harmful combination of articles, the computer program product comprising a computer readable storage medium having program instructions embodied therewith, the program instructions executable by a processor to cause the processor to perform a method comprising: identifying a plurality of articles at one or more originating locations, the identifying including a type of the plurality of articles and a quantity of the plurality of articles; matching the plurality of articles with a repository of article descriptions that includes descriptive combinations of the articles that could combine to be a dangerous instrumentality to result in a plurality of matched articles with a potential to harm persons or property; identifying transport routes for the plurality of matched articles from the one or more originating locations to a terminating geographical zone; estimating a degree of completion of the dangerous instrumentality; and estimating a danger score of the plurality of matched articles, the danger score a composite of the type of the plurality of matched articles moved to the terminating geographical zone, the quantity of the plurality of matched articles moved to the terminating geographical zone and the degree of completion of the dangerous instrumentality.

### BRIEF DESCRIPTION OF SEVERAL VIEWS OF THE DRAWINGS

The features of the exemplary embodiments believed to be novel and the elements characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is an illustration of a geographical map showing the movement of articles from multiple originating locations to a terminating location.

FIG. 2 is an illustration of a process to identify and prevent development of dangerous instrumentalities using articles that by themselves may appear to be harmless.

FIG. 3 is an illustration of a security map showing an airport zone where apparently harmless articles have accumulated.

FIG. 4 is an illustration similar to FIG. 3 of a security map showing an airport zone where a greater quantity than shown in FIG. 3 of apparently harmless articles have accumulated.

FIG. 5 is an illustration of a security map showing several zones where apparently harmless articles have accumulated and steps have been taken to limit the further accumulation of the apparently harmless articles.

FIG. 6 is an illustration of a system which may embody the process of FIG. 2.

### DETAILED DESCRIPTION

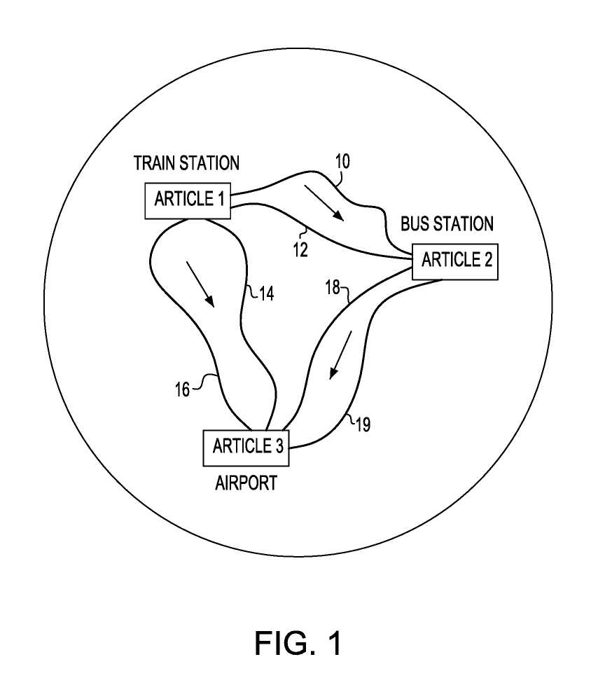

Referring to the Figures in more detail, and particularly referring to FIG. 1, there is illustrated the problem encountered by security officers. A first article (“article 1”) may be discovered at a train station by scanning or other means. This first article may be a harmless object when not combined with other objects. It is possible that the person carrying article 1 may travel by various routes 10, 12 to the bus station or by various routes 14, 16 to the airport.

A second article (“article 2”) may be discovered at a bus station by scanning or other means. This second article may also be a harmless object when not combined with other objects. It is possible that the person carrying article 2 may travel by various routes 18, 19 to the airport.

A third article (“article 3”) may be discovered at the airport by scanning or other means. This third article may also be a harmless object when not combined with other objects.

Various scenarios may be surmised. In one scenario, the person carrying article 1 travels to the bus station by one of various routes 10, 12 and hands off article 1 to the person carrying article 2. The person carrying article 2 and now article 1 travels to the airport by one of various routes 18, 19 and meets the person carrying article 3 and they both pass through airport security and board an airplane. While each of articles 1, 2 and 3 may be harmless themselves, when combined together they may form a dangerous instrumentality.

A dangerous instrumentality here is an object that may harm or terrorize persons or property. Such an instrumentality may be, for example, an explosive, a harmful gas, a cutting, sharp or piercing implement or a firearm.

In another scenario, the person carrying article 1 travels to the airport by one of various routes 14, 16 and passes through airport security. The person carrying article 2 travels to the airport by one of various routes 18, 19 and passes through airport security. Finally, the person carrying article 3 passes through airport security. After passing through airport security, all three persons may meet up and pass the articles 1, 2 and 3 to one person and the other two persons leave the airport. However, to avoid suspicion, all three persons carrying their respective articles 1, 2 and 3 may separately board the aircraft even if the articles 1, 2 and 3 were passed off to one person before boarding the aircraft. While each of articles 1, 2 and 3 may be harmless themselves, when combined together they may form the dangerous instrumentality.

As used herein, “harmless article” and “apparently harmless article” have the same meaning which is that the article may be harmless by itself but when combined with other harmless articles may become harmful to persons or property.

At the present time, there is no security regimen that would track the movement of persons carrying the apparently harmless articles to their respective termination points and there is no security regimen that may predict that the separate travelers carrying the different apparently harmless articles may join up to combine the apparently harmless articles to form the dangerous instrumentality.

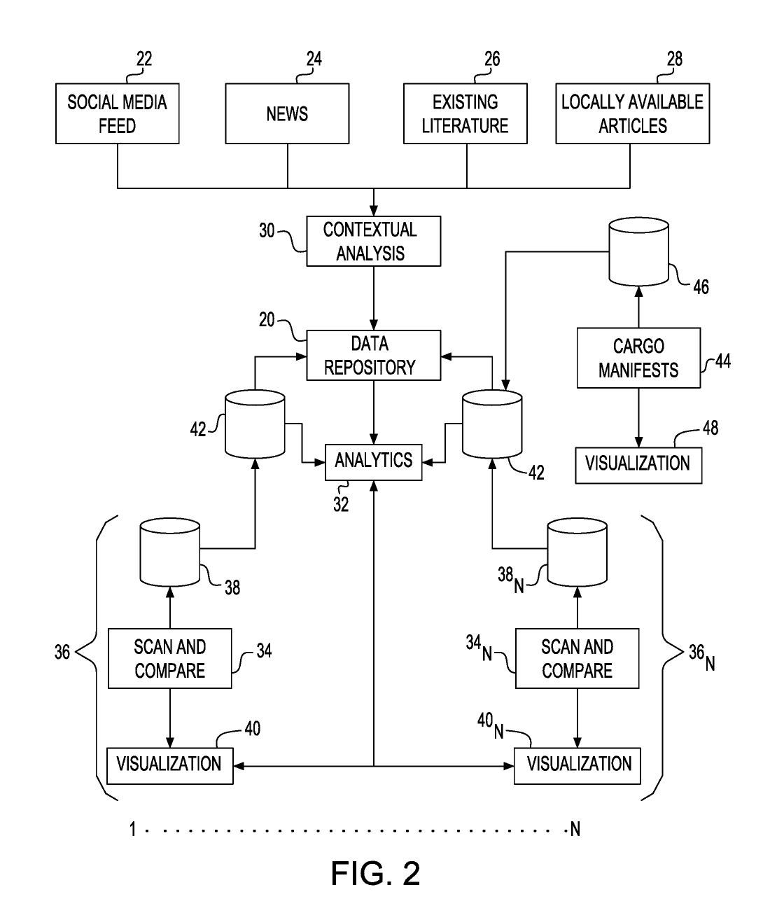

Referring now to FIG. 2, the present inventors have proposed a process to identify and prevent development of dangerous instrumentalities using articles that by themselves may appear to be harmless.

In a first step, a data repository 20 may be developed if such a data depository does not already exist. Feeds from social media 22, news articles 24, existing literature 26 and locally available articles 28 are analyzed to build the data repository 20 which maintains information from the feeds 22, 24, 26, 28 about articles that are apparently harmless but that could be used in harmful ways. The feeds 22, 24, 26, 28 may further contain information about the harmless articles that may be used in harmful ways when combined with other apparently harmless articles. While the data repository 20 collects information about articles that are apparently harmless, the data repository 20 may also collect information after articles that are apparently harmful. The data repository 20 may further contain information about articles that are usually carried by travelling persons.

All of the information from the feeds 22, 24, 26, 28 is fed for contextual analysis 30 to detect possible combinations of apparently harmless articles which could lead to dangerous instrumentalities if combined. The contextual analysis 30 is added to the data repository 20. The contextual analysis 30 in the data repository 20 is then applied with analytics 32 to arrive at a threat category from the articles in the data repository 20.

The analytics 32 may operate in the following manner. For example, multiple springs have been identified as being shipped to location Z on January 20 from Airport A. At the same time, 3D printing material has also been identified as being shipped to location Z from airport B on February 1. Data repository 20 may store various combinations of apparently harmless articles which may create a dangerous instrumentality. To create a three dimensional (3D) printed gun requires 3D printing material and springs. Individually the springs and 3D printed material are not dangerous whereas the combination can become a dangerous instrumentality. During any scanning process, if the analytics 32 identifies springs and 3D printing material being shipped to the same location, and from the data repository 20 it is found that the combination of the springs and 3D printing material may create the dangerous instrumentality, security officers may be apprised of this situation and may investigate further the shipments of springs and 3D printing material.

It may be that instead, the 3D printed material is shipped to location Y. In this case, the analytics 32 may predict that there could be another transportation of the 3D printed material from location Y to location Z or there could be another transportation of the springs from location Z to location Y.

There may be, in addition, visual representation of the articles in the data repository 20.

In the example above, the data repository 20 and analytics 32 may indicate that the springs and the 3D printing material may form the dangerous instrumentality. A visual representation, such as in the form of a pictograph, may be displayed to the security officers at the scanning stations, for example, such as a representation that the springs and 3D printed material may combine to produce the dangerous instrumentality. The locations where the apparently harmless articles are currently located may also be visually displayed such as on a map.

With regards to the threat category, an example might be where a person is carrying one spring, the threat category would be low while if the person is carrying hundreds of springs, the threat category would be higher.

In a further step, articles may be identified at one or more originating locations. The identification of articles may occur in different ways. Scanning may be used, or implemented if not currently used, at airports, train stations and bus stations. The scanning may be, for example, x-ray or ultrasound scanning. Based on the scanning, the shape, dimension, distribution of mass, density, pattern of articles, shade/color of articles may be identified on the person or in bags that the person is carrying or has checked as luggage. Based on a predefined learning rule, articles may be identified and/or predicted if not readily identified by the scanning. If there are any questions, security officers are empowered to check the person or bags manually and update the system.

As shown in FIG. 2, there are scan and compare stations 34 to 34N at each security checkpoint 36. There may be “N” security checkpoints 36 to 36N distributed in any geographical area. Each security checkpoint may be connected to storage 38 to 38N, to maintain a history of the scanned articles. The scan and compare units 34 to 34N may also retrieve from the storage 38 to 38N, the possible combinations of harmless articles that may result in a dangerous instrumentality. Data from the storage 38 to 38N, may also be sent to a central storage 42 that is accessible by the analytics 32 and data repository 20 so that the analytics 32 and data repository 20 may be continuously updated. Storage 38 to 38N may also receive data from central storage 42 pertaining to the possible combinations of harmless articles that may result in a dangerous instrumentality.

The scan and compare stations 34 to 34N, may further include a visualization function 40 to 40N, to provide visualization of the security threat on a security map to be discussed in more detail hereafter.

In addition to the scan and compare stations 34 to 34N, articles may be identified from cargo manifests 44 such as may occur when articles are shipped as cargo aboard a train, truck, ship or airplane. The cargo manifests 44 may have storage 46 to maintain a history of the articles in the cargo manifests 44. Possible combinations of harmless articles that may result in a dangerous instrumentality may also be retrieved from storage 46. Data from storage 46 may also be sent to central storage 42. The cargo manifests 44 may further include a visualization function 48 to provide visualization of the security threat on a security map to be discussed in more detail hereafter. Storage 46 may also receive data from central storage 42 pertaining to the possible combinations of harmless articles that may result in a dangerous instrumentality.

Based on data obtained from the scan and compare stations 34 to 34N, passenger ticketing information and the cargo manifests 44, possible geographic locations where the articles are concentrated (hereafter “sink points”) and the transport routes of the articles may be determined. That is, by correlating the article location movements and the passenger ticketing information with the data repository 20, which maintains possible combination of harmless articles which could lead to dangerous instrumentalities, the sink points and transport routes may be identified.

In a further step, based on the type of article and quantity of the articles moved to the sink-points, a danger score may be estimated. The danger score is a composite of the (i) type of the articles moved in to the sink point, (ii) quantity of the articles moved, (iii) degree of completion of the dangerous instrumentality by correlating the articles with inferences drawn from the contextual analysis 30 and the analytics 32.

A security map is a geographical map showing sink points (also referred to as zones) of security concern. Based on the danger score, the zones in the security map may be annotated with markings indicating zones of concern. These markings may be, for example, colors or different patterns. Based on the location movement of articles, the zones may get dynamically updated.

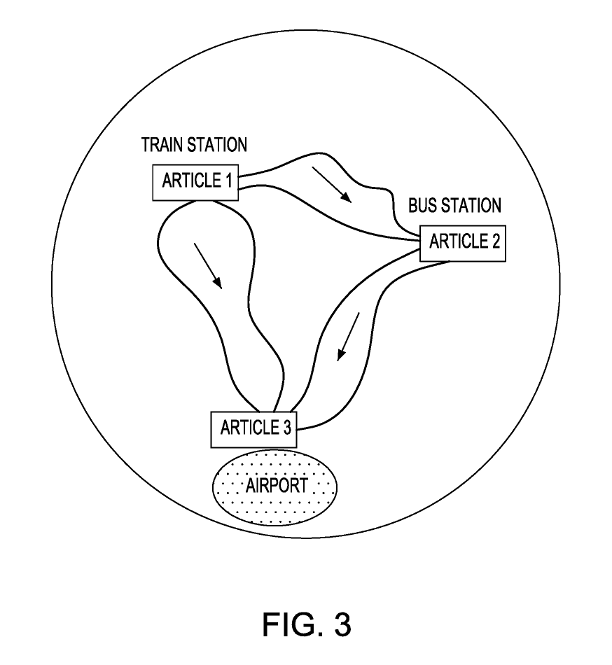

Referring to FIG. 3, there is shown a security map similar to the geographical map shown in FIG. 1. However, the security map indicates a zone encompassing the airport, hereafter the airport zone. The airport zone is a sink point as described previously. The airport zone has been annotated with a stipling marking indicating the movement of articles into the airport zone and an estimated danger score.

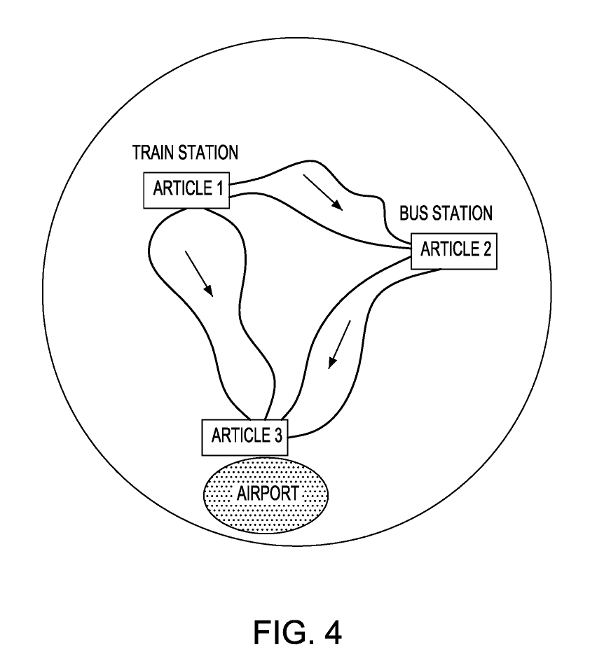

Referring to FIG. 4, the stipling marking for the airport zone has been darkened indicating a greater danger score. The darker marking may indicate that sufficient articles have been moved into the airport zone such that completion of a dangerous instrumentality is imminent.

Knowing the location of apparently harmless articles and the predicted transport routes for these apparently harmless articles, security officers may proactively act to prevent these apparently harmless articles from entering certain zones based on the markings of these zones. The exemplary embodiments know approximately how many and of what type apparently harmless articles are present in a given zone and can figure out possible articles which, when entering the zones, may lead to a greater possibility of completing the dangerous instrumentality. Based on the foregoing analysis, security officers may tag these apparently harmless articles as critical articles and will notify police officials to prevent these articles from entering the zones.

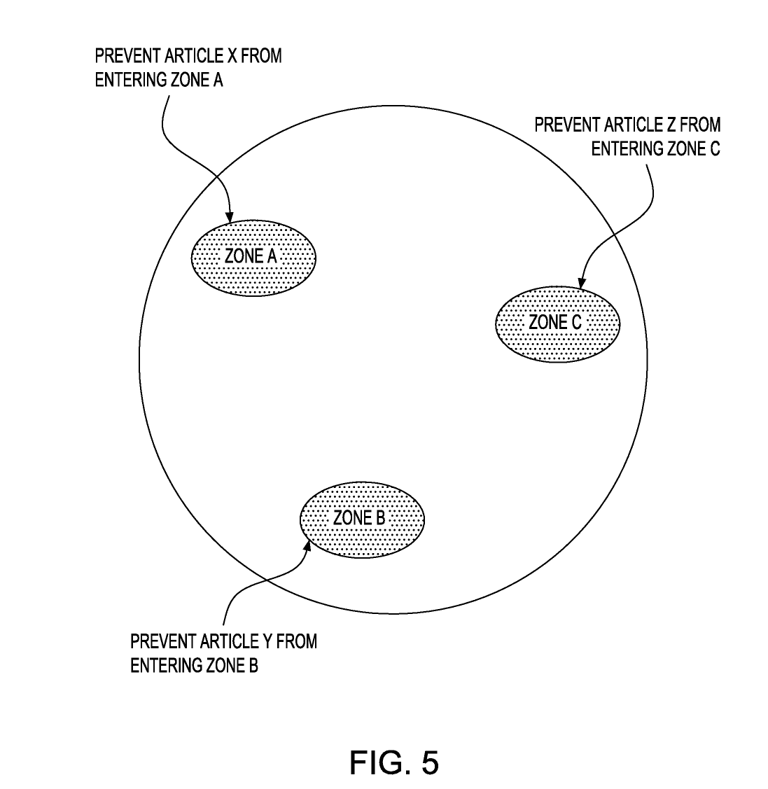

Referring now to FIG. 5, there is illustrated a geographical map having three zones where apparently harmless articles but potentially harmful articles when combined with other apparently harmless articles have been transported into the three zones. For purposes of illustration and not limitation, the apparently harmless articles are different for each zone. According to the exemplary embodiments, security officers proactively want to prevent X-type articles from entering zone A, Y-type articles from entering zone B and Z-type articles from entering zone C.

It should be understood that while the exemplary embodiments have been described with reference to apparently harmless articles, the exemplary embodiments are also applicable to situations in which at least some of the articles transported into a zone may be apparently harmful articles which are to be combined with other apparently harmless articles.

The visualizations described previously and shown in FIGS. 3 to 5 may be interactive. Visual representation and correlation of possible events may be executed using a combination of one or more articles carried by a passenger or group of passengers. Location-based aggregation may be performed of already transported/delivered articles through various routes/channels and may be plotted in an electronic map. Accordingly, the predicted travel route of the articles may be identified to bring the delivered articles together and make the final product which may be a dangerous instrumentality.

The exemplary embodiments may identify if any additional articles are required to make a final product and then predict the additional articles and quantity of the additional articles to be transported and transportation destination. Accordingly, security officers may take proactive action to thwart the transport of the additional articles.

The exemplary embodiments may show a pattern of each article movement over a period of time, and accordingly may predict possible planning of an event because of the accumulation of articles over a period of a time.

The exemplary embodiments may also maintain the location of articles that are available easily in the specific location and how such articles combined with others may result in a harmful final product.

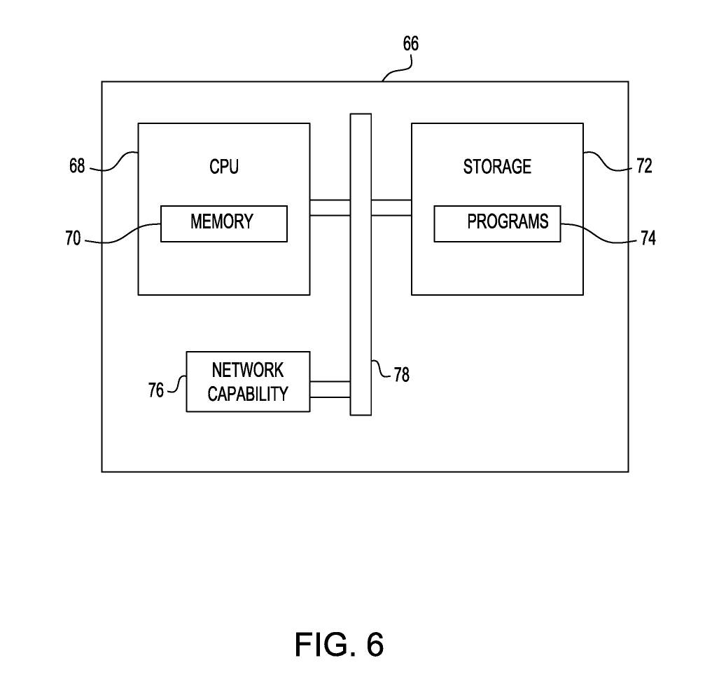

Referring now to FIG. 6, there is illustrated a system 66 which may embody the process of FIG. 2. The system 66 may include a central processing unit 68 having memory 70. The system 66 may further include a computer readable storage medium 72 which may be located within system 66 or may be located remote from system 66. The computer readable storage medium 72 may include programs 74 such as a program for implementing the process of FIG. 1. Further included within system 66 may be network capability 76, which may include for the purpose of illustration and not limitation WiFi, cellular, satellite, near field communication and short range radio such as Bluetooth, for communicating with the Internet or other systems. All of the components within system 66 may be connected by a bus 78.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A method of tracking a harmful combination of articles comprising:
identifying a plurality of articles at one or more originating locations, the identifying including a type of the plurality of articles and a quantity of the plurality of articles;
matching the plurality of articles with a repository of article descriptions that includes descriptive combinations of the articles that could combine to be a dangerous instrumentality to result in a plurality of matched articles with a potential to harm persons or property;
identifying transport routes for the plurality of matched articles from the one or more originating locations to a terminating geographical zone;
estimating a degree of completion of the dangerous instrumentality; and
estimating a danger score of the plurality of matched articles, the danger score a composite of the type of the plurality of matched articles moved to the terminating geographical zone, the quantity of the plurality of matched articles moved to the terminating geographical zone and the degree of completion of the dangerous instrumentality.

2. The method of claim 1 wherein the repository of articles comprises (i) information about articles that could be used, alone or in combination, in a harmful way from social media, news articles, existing literature and locally available articles and (ii) information about the articles that indicates that the articles are usually carried by a travelling person or traveled as cargo.

3. The method of claim 1 wherein identifying a plurality of articles comprising scanning at least one of a person, a person's carryon baggage or a person's checked baggage.

4. The method of claim 1 wherein identifying a plurality of articles comprising examining a cargo manifest for the plurality of articles shipped as cargo.

5. The method of claim 1 further comprising plotting the danger score on a security map such that the danger score has been transposed to a pattern or color indicative of the danger score.

6. The method of claim 1 further comprising dynamically updating the danger score as the danger score changes.

7. The method of claim 1 further comprising predicting an additional plurality of articles necessary for completion of the dangerous instrumentality and preventing the additional plurality of articles from reaching the terminating geographical zone.

8. A system for tracking a harmful combination of articles comprising:
a computer readable storage medium; and
a processor that executes the instructions to perform the following functions:
identify a plurality of articles at one or more originating locations, the identify including a type of the plurality of articles and a quantity of the plurality of articles;
match the plurality of articles with a repository of article descriptions that includes descriptive combinations of the articles that could combine to be a dangerous instrumentality to result in a plurality of matched articles with a potential to harm persons or property;
identify transport routes for the plurality of matched articles from the one or more originating locations to a terminating geographical zone;
estimate a degree of completion of the dangerous instrumentality; and
estimate a danger score of the plurality of matched articles, the danger score a composite of the type of the plurality of matched articles moved to the terminating geographical zone, the quantity of the plurality of matched articles moved to the terminating geographical zone and the degree of completion of the dangerous instrumentality.

9. The system of claim 8 wherein the repository of articles comprises (i) information about articles that could be used, alone or in combination, in a harmful way from social media, news articles, existing literature and locally available articles and (ii) information about the articles that indicates that the articles are usually carried by a travelling person or traveled as cargo.

10. The system claim 8 wherein identify a plurality of articles comprises scan at least one of a person, a person's carryon baggage or a person's checked baggage.

11. The system of claim 8 wherein identify a plurality of articles comprises examining a cargo manifest for the plurality of articles shipped as cargo.

12. The system of claim 8 further comprises plot the danger score on a security map such that the danger score has been transposed to a pattern or color indicative of the danger score.

13. The system of claim 8 further comprises dynamically update the danger score as the danger score changes.

14. The system of claim 8 further comprises predict an additional plurality of articles necessary for completion of the dangerous instrumentality and prevent the additional plurality of articles from reaching the terminating geographical zone.

15. A computer program product for tracking a harmful combination of articles, the computer program product comprising a computer readable storage medium having program instructions embodied therewith, the program instructions executable by a processor to cause the processor to perform a method comprising:
identifying a plurality of articles at one or more originating locations, the identifying including a type of the plurality of articles and a quantity of the plurality of articles;
matching the plurality of articles with a repository of article descriptions that includes descriptive combinations of the articles that could combine to be a dangerous instrumentality to result in a plurality of matched articles with a potential to harm persons or property;
identifying transport routes for the plurality of matched articles from the one or more originating locations to a terminating geographical zone;
estimating a degree of completion of the dangerous instrumentality; and
estimating a danger score of the plurality of matched articles, the danger score a composite of the type of the plurality of matched articles moved to the terminating geographical zone, the quantity of the plurality of matched articles moved to the terminating geographical zone and the degree of completion of the dangerous instrumentality.

16. The computer program product of claim 15 wherein the repository of articles comprises (i) information about articles that could be used, alone or in combination, in a harmful way from social media, news articles, existing literature and locally available articles and (ii) information about the articles that indicates that the articles are usually carried by a travelling person or traveled as cargo.

17. The computer program product of claim 15 wherein identifying a plurality of articles comprising scanning at least one of a person, a person's carryon baggage or a person's checked baggage or examining a cargo manifest for the plurality of articles shipped as cargo.

18. The computer program product of claim 15 further comprising plotting the danger score on a security map such that the danger score has been transposed to a pattern or color indicative of the danger score.

19. The computer program product of claim 15 further comprising dynamically updating the danger score as the danger score changes.

20. The computer program product of claim 15 further comprising predicting an additional plurality of articles necessary for completion of the dangerous instrumentality and preventing the additional plurality of articles from reaching the terminating geographical zone.
